(19) United States
(12) Patent Application Publication
(10) Pub. No.: US 2006/0221045 A1
(43) Pub. Date: Oct. 5, 2006

(54) Backlight unit and liquid crystal display device integrated with the same

(75) Inventors: Sung-Soo Kim, Suwon-si (KR); Hyoung-Bin Park, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/377,435

(22) Filed: Mar. 17, 2006

(30) Foreign Application Priority Data
Mar. 31, 2005 (KR) 10-2005-0027025

(51) Int. Cl. G09G 3/36

(52) U.S. Cl. 345/102

(57) ABSTRACT

A backlight unit and a liquid crystal display device into which the backlight unit is integrated are provided. The backlight unit includes a first substrate and a second substrate facing each other and spaced apart to provide a discharge space, a plurality of barrier ribs for forming a plurality of discharge cells by partitioning the discharge space, a phosphor layer formed on inner walls of the discharge cells, a first electrode formed on an inner surface of the first substrate and grounded, and a second electrode corresponding to at least one discharge cell.

### CROSS-REFERENCE TO RELATED APPLICATION

This application claims priority to and the benefit of Korean Patent Application No. 10-2005-0027025, filed on Mar. 31, 2005, which is hereby incorporated by reference for all purposes as if fully set forth herein.

### BACKGROUND OF THE INVENTION

1. Field of the Invention

The present invention relates to a backlight unit and a liquid crystal display device having the backlight unit, and more particularly, to a backlight unit including a facing discharge flat lamp structure that may prevent electromagnetic interference (EMI) with the liquid crystal display device, and a liquid crystal display having the backlight unit.

2. Discussion of the Background

Generally, liquid crystal display (LCD) devices, which are passive displays, form an image using externally supplied light rather than generating their own light. A backlight unit may be arranged behind the LCD panel to provide the necessary light.

Cold cathode fluorescent lamps (CCFLs) have typically been used as the LCD device backlight. However, the CCFL has a relatively short lifetime and its color reproduction characteristic is not good. Furthermore, the CCFL cannot be lighted in synchronization with an image scanning time of the LCD device since the CCFL requires a certain time for lighting. This may cause motion blur, which is a latent image remaining on the LCD when the image changes. Furthermore, the CCFL uses mercury, which is regulated by law and may cause environmental problems, especially with a large LCD backlight.

To avoid these drawbacks of the CCFL, a backlight unit has been developed that uses a point light source, such as light emitting diode. Korea Patent Application No. 10-2003-0019834, titled “Structure of Backlight Unit for Liquid Crystal Display,” and Korea Parent Application No. 10-2003-0023052, titled “Structure of Backlight Unit for Liquid Crystal Display,” disclose examples of such backlight units. However, since the LED is a point light source, it requires additional optical structures, such as a light guide panel and a prism, to uniformly radiate light onto a wide surface. Therefore, it is difficult to make such a backlight unit thin. Also, a high brightness LED is employed to obtain bright light, thereby reducing the backlight unit's energy efficiency.

To overcome the above drawbacks, a Xenon (Xe) flat lamp, which uses the light emitting principle of a plasma display panel, may be utilized as the backlight unit. Such flat lamps may be facing discharge or surface discharge types according to their electrode arrangement. The facing discharge lamp includes a pair of electrodes located respectively on an upper substrate and a lower substrate, and the electrode pair generates a discharge that is perpendicular to the substrates. The surface discharge lamp includes a pair of electrodes arranged on the same substrate, and the electrode pair generates a discharge that is parallel to the substrate. U.S. Pat. Nos. 4,638,218 and 5,661,500 disclose the surface discharge structure.

When the backlight unit is integrated into the LCD panel, the overall thickness of the LCD module may be reduced, light loss may be reduced, and expensive elements, such as an optical seat, may be omitted. However, when a backlight unit such as a flat lamp is integrated into the LCD, a driving problem may occur since noise caused by electromagnetic interference (EMI) from high voltage switching in the backlight may infiltrate the LCD panel. Also, heat generated in the backlight may be directly conducted to the LCD panel.

### SUMMARY OF THE INVENTION

The present invention provides a backlight unit that that may decrease the amount of heat and electromagnetic interference (EMI) that affects an LCD panel, and a LCD device into which the backlight unit is integrated.

Additional features of the invention will be set forth in the description which follows, and in part will be apparent from the description, or may be learned by practice of the invention.

The present invention discloses a backlight unit located on the rear surface of a liquid crystal display panel to radiate light. The backlight unit includes a first substrate and a second substrate facing each other with a discharge space therebetween, a plurality of barrier ribs partition the discharge space to define a plurality of discharge cells having a stripe shape, and a phosphor layer is arranged on inner walls of the discharge cells. A grounded first electrode is arranged on a surface of the first substrate, and a second electrode corresponds to at least one discharge cell and is arranged between the second substrate and the phosphor layer.

The present invention also discloses a liquid crystal display device having an LCD panel and a backlight unit. The LCD panel includes a liquid crystal between a front substrate and a rear substrate, and the backlight unit is located on the rear surface of the LCD panel to radiate light. The backlight unit includes a first substrate and a second substrate facing each other with a discharge space therebetween, a plurality of barrier ribs partition the discharge space to define a plurality of discharge cells having a stripe shape, and a phosphor layer is arranged on inner walls of the discharge cells. A grounded first electrode is arranged on a surface of the first substrate, and a second electrode corresponds to at least one discharge cell and is arranged between the second substrate and the phosphor layer. The first substrate is integrated with the LCD panel.

The present invention also discloses a method for driving a liquid crystal display device having a liquid crystal display panel, which includes a liquid crystal between a front substrate and a rear substrate, and a backlight unit to radiate light to the liquid crystal display panel. The method includes synchronizing the discharge time of discharge cells of the backlight unit with the scanning time of the corresponding portion of the liquid crystal display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a backlight unit according to a first embodiment of the present invention.

FIG. 2 is a cross-sectional view of the backlight unit according to the first embodiment of the present invention.

FIG. 3 is a cross-sectional view of a backlight unit according to a second embodiment of the present invention.

FIG. 4 is a perspective view of an LCD device integrated with the backlight unit according to the first embodiment of the present invention.

### DETAILED DESCRIPTION OF THE ILLUSTRATED EMBODIMENTS

The present invention will now be described more fully with reference to the accompanying drawings in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals refer to like elements throughout the drawings.

It will be understood that when an element such as a layer, film, region or substrate is referred to as being “on” another element, it can be directly on the other element or intervening elements may also be present. In contrast, when an element is referred to as being “directly on” another element, there are no intervening elements present.

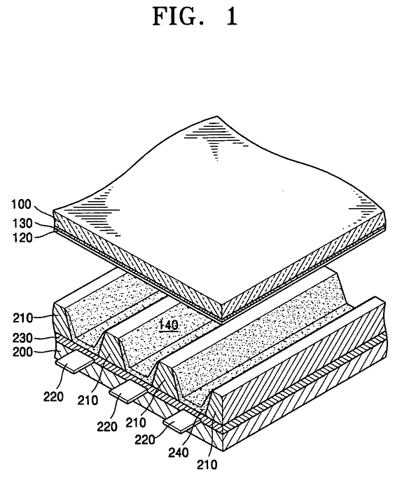

FIG. 1 is a perspective view of a backlight unit according to a first embodiment of the present invention. Referring to FIG. 1, a first substrate 100 and a second substrate 200 are sealed at the edges (not shown) to provide a discharge space therebetween. An LCD panel may be located above the first substrate 100, and a backlight unit according to the present embodiment emits light through the first substrate 100. Accordingly, the first substrate 100 and elements formed on the first substrate 100 are capable of transmitting light.

A first electrode 130 may be arranged on the inner surface of the first substrate 100. The first electrode 130 is formed to have an approximately equal electrical potential over the entire inner surface of the first substrate 100, and it may be grounded. The first electrode 130 may be formed as a single film, or it may be formed in various patterns that can shield discharge and electromagnetic waves, such as a grid. The first electrode 130 may be formed of a transparent conductive material, such as indium tin oxide (ITO). A protection film 120, which may be formed of magnesium oxide (MgO), is arranged to substantially cover the first electrode 130. The protection film 120 is a transparent thin film that may protect the first electrode 130 from plasma. A dielectric film (not shown) may be included between the first electrode 130 and the protection film 120.

A plurality of barrier ribs 210 are arranged on the inner surface of the second substrate 200. The barrier ribs 210 provide a plurality of discharge cells 140 by partitioning the discharge space between the first substrate 100 and the second substrate 200. A plurality of second electrodes 220 are arranged on the inner surface of the second substrate 200, which is located at a lower part of the discharge cell 140. The second electrodes 220 may be metallic electrodes having a low specific resistance, since they need not be capable of transmitting light.

A phosphor layer 240 is arranged on the inner walls of the discharge cells 140. For example, the phosphor layer 240 may be arranged on both sides of the barrier ribs 210 and above the second electrodes 220. The phosphor layer 240 may be formed of a material that emits white light when excited by ultraviolet rays. A dielectric layer 230 is arranged between the second electrodes 220 and the phosphor layer 240.

The second electrodes 220 may be formed in stripes corresponding to each of the discharge cells 140. Wider second electrodes (not shown) may be formed corresponding to a discharge cell group, which includes at least two adjacent discharge cells. When discharge cell groups are formed of at least two adjacent discharge cells, a bus electrode may electrically couple the second electrodes 220 corresponding to each of the discharge cells 140 of the discharge cell group.

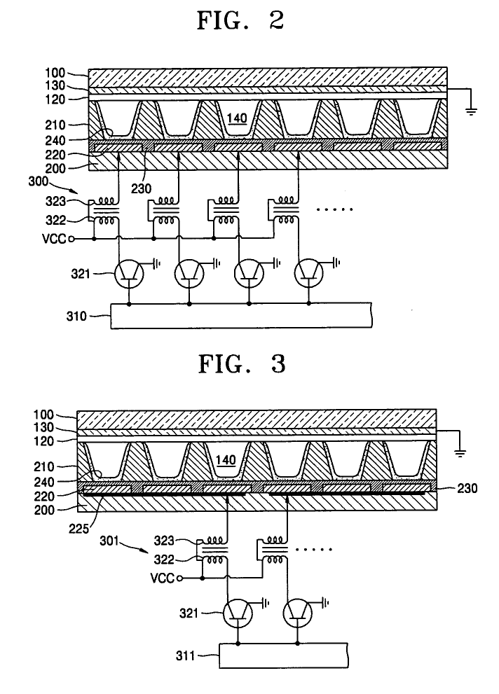

FIG. 2 is a cross-sectional view of the backlight unit according to the first embodiment of the present invention. The principle of light emission of the backlight unit according to the present invention will now be described with reference to FIG. 2.

Referring to FIG. 2, a plurality of second electrodes 220, which correspond to the discharge cells 140, are included on the inner surface of the second substrate 200. The second electrodes 220 are electrically coupled with a voltage applying unit. Here, the first electrode 130 is grounded. When applying a discharge voltage that exceeds a minimum discharge voltage to the second electrodes 220, a discharge is generated between the first electrode 130 and the second electrodes 220. Afterward, the process of emission of visible light from the phosphor layer 240 by the ultraviolet ray emission of an excited gas, such as Xe, is identical to that of a conventional flat lamp.

The voltage applying unit may include a plurality of high voltage induction circuits 300 that generate the voltage to be applied to the second electrodes 220, and a controller 310 that sequentially sends switching signals to the high voltage induction circuits 300. The controller 310 may control the high voltage induction circuits 300 to be synchronized with the vertical scanning signal of an LCD panel, so that the discharge voltage may be sequentially applied to the second electrodes 220 corresponding to each of the discharge cells 140.

For example, the high voltage induction circuit 300 may include a switching transistor 321, which is controlled by the controller 310, a first coil 322, which the switching transistor 321 turns on and off, and a second coil 323, which generates an induced electromotive force that exceeds a breakdown voltage by a counter electromotive force generated when the first coil 322 is switched on/off. The output terminals of the second coil 323 may be respectively electrically coupled with the second electrodes 220.

One frame of an image is typically scanned from the top to the bottom of a liquid crystal display panel, and the scanning of the next frame begins at the top before completing the first frame. In a conventional backlight unit that uses a CCFL, it may be difficult to remove motion blur because the backlight unit irradiates light onto the entire LCD panel regardless of the panel's scanning sequence. However, the backlight unit according to embodiments of the present invention may effectively remove motion blur since the plural discharge cells 140, which are formed in a horizontal line, sequentially emit light in synchronization with the vertical scanning of the LCD panel. Also, a backlight unit according to embodiments of the present invention may reduce the amount of heat it generates, and it may enhance energy efficiency by reducing unnecessary light emission.

FIG. 3 is a cross-sectional view of a backlight unit according to a second embodiment of the present invention. According to the second embodiment of the present invention, the plurality of second electrodes 220 corresponding to each of the discharge cells 140 are electrically coupled together in groups by bus lines 225, and each group may include at least two second electrodes 220. FIG. 3 shows the groups including three second electrodes 220. Here, the plural bus lines 225 are respectively electrically coupled with output terminals of a high voltage induction circuit 301. Therefore, the controller 311 may regulate supply of the discharge voltage to each unit of the discharge cell groups. As another example, though not shown, each second electrode 220 may be wider so that it corresponds to at least two discharge cell regions.

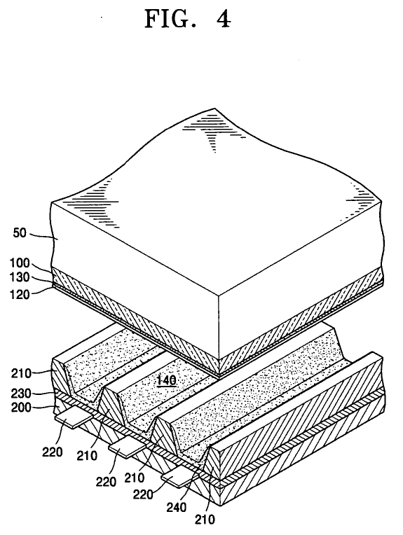

FIG. 4 is a perspective view of an LCD device integrated with a backlight unit according to the first embodiment of the present invention. An LCD device according to the present embodiment includes an LCD panel 50 and a backlight unit that radiates light onto the LCD panel 50. The LCD panel 50 includes an orientation film, a spacer, and a color filter between a front substrate and a rear substrate, and may be sealed with a liquid crystal material contained therein. The LCD panel 50 may be formed according to techniques that are well known in the art. Here, the detailed internal structure of the LCD panel 50 will be omitted.

In the LCD device integrated with a backlight unit according to embodiments of the present invention, the LCD panel 50 and the backlight unit may share one substrate respectively as a rear substrate and a first substrate. In other words, the rear substrate of the LCD panel 50 may double as the first substrate 100 of the backlight unit, and the inner structure of the LCD panel 50 is formed thereon. Therefore, the first substrate 100 may be formed to serve as the rear substrate of the LCD panel 50. It is difficult to integrate an LCD device with a conventional backlight unit due to the generation of excessive heat and EMI. However, according to embodiments of the present invention, as described above, the backlight unit's grounded first electrode 130 blocks EMI, and the divided discharges of the plurality of discharge cells 140 may effectively reduce generated heat. Therefore, it may be possible to integrate an LCD panel with a facing discharge type backlight unit.

Alternatively, the rear substrate of the LCD panel 50 and the first substrate 100 of the backlight unit may be joined after they are separately manufactured, and a structure, such as a polarized film, may be included therebetween.

According to embodiments of the present invention, a backlight unit may have high discharge efficiency and a facing discharge type flat lamp structure, which may improve the problems of heat and EMI. Also, an LCD device integrated with the backlight unit having a minimized thickness may be provided, giving the same advantages.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A backlight unit arranged behind a liquid crystal display panel to radiate light, the backlight unit comprising:
a first substrate and a second substrate facing each other with a discharge space therebetween;
a plurality of barrier ribs partitioning the discharge space to define a plurality of discharge cells having a stripe shape;
a phosphor layer arranged on inner walls of the discharge cells;
a first electrode arranged on a surface of the first substrate that faces the second substrate, the first electrode being grounded; and
a second electrode corresponding to at least one discharge cell and arranged between the second substrate and the phosphor layer.

2. The backlight unit of claim 1, wherein the first electrode is formed to have approximately the same electric potential over the entire surface of the first substrate.

3. The backlight unit of claim 1, wherein the first electrode comprises a single transparent film.

4. The backlight unit of claim 1, further comprising:
a protection film that protects the first electrode during discharge.

5. The backlight unit of claim 1, wherein one second electrode is arranged corresponding to each discharge cell.

6. The backlight unit of claim 5, wherein the discharge time of each discharge cell is synchronized with the scanning time of the corresponding portion of the liquid crystal display panel.

7. The backlight unit of claim 1, wherein the second electrode corresponds to a discharge cell group comprising at least two adjacent discharge cells.

8. The backlight unit of claim 7, wherein the discharge time of each discharge cell group is synchronized with the scanning time of the corresponding portion of the liquid crystal display panel

9. The backlight unit of claim 1, further comprising:
a bus line,
wherein one second electrode corresponds to each discharge cell, a discharge cell group comprises at least two adjacent discharge cells, and the bus line couples the second electrodes of the at least two adjacent discharge cells together.

10. The backlight unit of claim 9, wherein the discharge time of each discharge cell group is synchronized with the scanning time of the corresponding portion of the liquid crystal display panel.

11. The backlight unit of claim 1, further comprising:
a switching transistor,
wherein when each discharge cell discharges, a discharge start voltage applied to the second electrode is generated by a counter electromotive force due to on/off switching of the switching transistor.

12. A liquid crystal display device, comprising:
a liquid crystal display panel comprising a liquid crystal between a front substrate and a rear substrate; and
a backlight unit to radiate light to the liquid crystal display panel,
wherein the backlight unit comprises:
a first substrate and a second substrate facing each other with a discharge space therebetween;
a plurality of barrier ribs partitioning the discharge space to define a plurality of discharge cells having a stripe shape;
a phosphor layer arranged on inner walls of the discharge cells;
a first electrode arranged on a surface of the first substrate that faces the second substrate, the first electrode being grounded; and
a second electrode corresponding to at least one discharge cell and arranged between the second substrate and the phosphor layer, and
wherein the first substrate is integrated with the liquid crystal display panel.

13. The liquid crystal display device of claim 12, wherein the rear substrate of the liquid crystal display panel and the first substrate of the backlight unit are coupled to each other.

14. The liquid crystal display device of claim 12, further comprising:
a polarized film arranged between the rear substrate of the liquid crystal display panel and the first substrate of the backlight unit.

15. The liquid crystal display device of claim 12, wherein the rear substrate of the liquid crystal display panel also serves as the first substrate of the backlight unit.

16. The liquid crystal display device of claim 12, wherein the first electrode is formed to have approximately the same electric potential over the entire surface of the first substrate.

17. The liquid crystal display device of claim 12, wherein the first electrode comprises a single transparent film.

18. A method of driving a liquid crystal display device having a liquid crystal display panel comprising a liquid crystal between a front substrate and a rear substrate, and a backlight unit to radiate light to the liquid crystal display panel, the method comprising:
synchronizing the discharge time of discharge cells of the backlight unit with the scanning time of the corresponding portion of the liquid crystal display panel.
